(19) United States
(12) Patent Application Publication
(10) Pub. No.: US 2022/0075173 A1
(43) Pub. Date: Mar. 10, 2022

(54) AUTOMATED MICROSCOPE OBJECTIVE DETECTOR

(71) Applicant: GOOGLE LLC, Mountain View, CA (US)

(72) Inventor: Robert MACDONALD, Mountain View, CA (US)

(21) Appl. No.: 17/421,613

(22) PCT Filed: Jan. 8, 2019
(86) PCT No.: PCT/US2019/012674

§ 371 Date: Jul. 8, 2021

(51) Int. Cl. G02B 21/24; G02B 21/02; G01C 19/00; G01P 15/18; G01P 1/00; G01P 15/08

(52) U.S. Cl. CPC G02B 21/24; G02B 21/02; G01P 15/08; G01P 15/18; G01P 1/00; G01C 19/00

(57) ABSTRACT

A microscope can be retrofitted with a nosepiece configured with a miniaturized inertial measurement sensor and an associated wireless transmitter that functions to relay information as to the current position of the nosepiece as determined by the inertial measurement sensor thereby indicating which objective lens is in the optical path to an external computing device. Alternatively, the nosepiece can configured with a miniaturized inertial measurement sensor generating an electrical signal indicating the current position of the nosepiece or equivalently the current objective lens in the optical path, and a cable for carrying power to the sensor, the electrical signal to internal electronics of the microscope, or both. This latter configuration is suitable in the situation where the microscope is configured with this arrangement, as manufactured.

This disclosure relates generally to the field of microscopy and more particularly to a method and system for determining automatically which of several possible objective lenses has been placed into the optical path of a microscope.

A nosepiece is a mechanical, rotatable fixture which has discrete positions, each of which serve to hold an objective lens of the microscope. Typically, a nosepiece has 4, 5, 6 or 7 such positions in order to accommodate a variety of different objective lenses that might be used to view a specimen. The user rotates the nosepiece about an axis to place a desired objective lens (e.g., 10×, 40×, etc.) into the optical path of the microscope.

Coded nosepieces which determine automatically the current object lens that is in the optical path are known, and are believed to use electro-mechanical devices such as Hall sensors to provide the positional information. It has also been proposed to use a camera which either reads bar-codes that are positioned on the lenses or the color or numbers on the lenses. Another proposal is to use an RFID chip placed on the lenses and a coil on the microscope to determine which objective lens is in the optical path.

### SUMMARY

In one aspect, a microscope is described having a nosepiece comprising a mechanical fixture having discrete positions which serve to hold a plurality of different objective lenses, one of which is rotated into an optical path of the microscope to view or capture an image of a specimen. The nosepiece is configured with a miniaturized inertial measurement sensor and an associated wireless transmitter that functions to relay information as to the current position of the nosepiece, as determined by the inertial measurement sensor thereby indicating which objective lens is in the optical path, to an external computing device.

The term “inertial measurement sensor”, or “sensor” herein, is intended to refer to a motion sensor which is configured to detection motion and therefore changes in relative position or orientation of the sensor. Such a sensor is typically configured as one or more accelerometers, gyroscopes, or a combination thereof. The inertial measurement sensor could optionally also include a magnetometer (in addition to accelerometers and/or gyroscopes). The accelerometers and gyroscopes can be 1-, 2- or 3-axis sensors. The term “miniaturized” means simply that the inertial measurement sensor is sized in a small form factor sufficiently compact that it can be affixed or built into the nosepiece without compromising the functionality or ergonomics of the nosepiece to hold a plurality of different objective lenses. Currently available inertial measurement sensors and wireless transmitters on the scale of 1 inch or less, using MEMS (Micro Electro-Mechanical Systems) technology, are examples of a “miniaturized” inertial measurement sensor.

In one configuration, the inertial measurement sensor includes computational resources to synthesize signals from multiple inertial measurement sensors and report an absolute orientation of the inertial measurement sensor.

In another configuration, the inertial measurement sensor and wireless transmitter are integrated as a single unit and powered by a battery. In this configuration, a preferred embodiment includes a mounting arrangement or holder for mounting the single unit to the nosepiece such that if the single unit is removed from the nosepiece to replace or recharge the battery the single unit can be installed on the mounting arrangement in the same orientation with respect to the nosepiece as it was when it was removed. For example, the mounting arrangement can have tabs, slots or other features which cooperate with the form factor of the single unit such that the single unit can only be installed in a particular orientation. This technique avoids the need for re-calibration of the inertial measurement sensor positions after removal to change or charge the battery.

The embodiment with the wireless transmitter is ideally suitable for a retrofit installation of the microscope objective detector onto an existing microscope to add this functionality. In other embodiments, the microscope is fitted with this capability when new. The nosepiece includes a miniaturized inertial measurement sensor generating an electrical signal indicating the current position of the nosepiece or equivalently the current objective lens in the optical path, and a cable for carrying the electrical signal to internal electronics of the microscope. The position of the nosepiece and hence which lens is in the optical path can be reported to the user via a user interface on the microscope. In one embodiment, the cable is configured to supply power to the inertial measurement sensor, thereby avoiding the need for replacement or recharging of a battery for the sensor. In another possible configuration, the internal electronics of the microscope is configured to report the current position of the nosepiece, or equivalently the current objective lens in the optical path, to an external computing device, for example a workstation which is coupled to the microscope and includes a monitor to view magnified images of microscope specimens.

In still another aspect, a method of operating a microscope is disclosed which includes the steps of rotating a nosepiece holding a plurality of different objective lenses such that one of the objective lenses is placed into an optical path of the microscope; measuring the rotational position of the nosepiece with a miniaturized inertial measurement sensor; and generating a signal with the inertial measurement sensor indicating the current position of the nosepiece, or equivalently the current objective lens in the optical path.

### BRIEF DESCRIPTION OF THE DRAWINGS

FIG. 1 is a schematic diagram of a microscope which is configured with the automatic microscope objective detector feature of this disclosure. The details of the microscope and ancillary equipment shown in FIG. 1 is not particularly important and can vary widely from the disclosed embodiment.

FIG. 2 is a perspective view of a nosepiece for a microscope with a miniaturized inertial measurement sensor and wireless transmitter in the form factor of a single unit mounted in the center of the nosepiece.

FIG. 3 is another view of the nosepiece of FIG. 2, showing an optional sensor mount.

FIG. 4 is a view of the nosepiece of FIGS. 2 and 3 incorporated into the microscope.

FIG. 5 is a more detailed view of the nosepiece and sensor of FIG. 4. In this configuration the sensor mount consists of an adhesive putty.

FIG. 6 is an isolated view of a nosepiece with a sensor and a cable supplying electrical power to the inertial measurement sensor. Signals conveying position information may be transmitted wireless to an external computing device or via the cable to the internal electronics of the microscope.

FIG. 7 is a schematic diagram of the electronics of an integrated miniaturized inertial measurement sensor and wireless transmitter.

### DETAILED DESCRIPTION OF PREFERRED EMBODIMENT

A microscope is described having a nosepiece which is configured with a miniaturized inertial measurement sensor (e.g., a combination of accelerometers and/or gyroscopes, currently embodied in MEMS technology) and a wireless transmitter (e.g., WIFI or Bluetooth) that functions to relay information as to the current position of the nosepiece, or equivalently which objective lens has been placed in the microscope's optical path, to an external computing device, e.g., workstation associated with the microscope, smart phone, laptop computer or other computing unit.

The inertial measurement sensor and wireless transmitter can be integrated as a single unit, e.g., the MetaMotionC Sensor from MBient Labs, which is based on a Bosch BMI160 chipset. The unit can be mounted to the nosepiece in any convenient manner, such as with an adhesive. The unit can be mounted in any available real estate on the nosepiece, for example the center of the nosepiece or in the space between nosepiece positions. In one embodiment, the nosepiece is configured with a mounting arrangement which includes mechanical features, e.g., tabs, slots, or form factor, to allow the single unit to be removed to charge or change a battery for the sensor and installed in the same orientation.

At the time of use, a calibration procedure is performed during which the different rotational positions of the nosepiece (and hence objective lens identifications) are correlated to position measurements of the inertial measurement sensor. The inertial measurement sensor and transmitter typically come with software development kits and apps that allow for easy configuration and set-up of the inertial measurement unit and performing the calibration.

The wireless signal conveying the sensor position is transmitted to an external computing device, e.g., desk-top computer or smart phone, typically which is associated with the microscope. Due to the initial calibration step, the computing device therefore has the information needed to identify the objective lens in the optical path and either report it to the user, e.g., on a display of the computing device, or assign metadata to digital images collected by the microscope which indicates the current object lens, or equivalently, magnification.

The configuration is a low cost, reliable, easy to install, and accurate retrofit solution to add intelligent nosepiece functionality to an existing microscope.

Alternatively, the sensor and wireless transmitter units can be incorporated into the microscope nosepiece at the time of manufacture and provided as standard equipment or as an upgrade to the microscope. In this embodiment, there is a microscope having a nosepiece comprising a mechanical fixture having discrete positions which serve to hold a plurality of different objective lenses, one of which is placed into an optical path of the microscope to view or capture an image of a specimen, the nosepiece further includes a miniaturized inertial measurement sensor generating an electrical signal indicating the current position of the nosepiece or equivalently the current objective lens in the optical path, and a cable for carrying the electrical signal to internal electronics of the microscope. In this configuration the sensor is wired into the internal electronics of the microscope via the cable, in which case the reporting of the nosepiece position could be provided directly via an electronic or software interface of the microscope. In this embodiment, power for the inertial measurement sensor could be provided via the cable connection and would not require the periodic replacement or charging of a sensor battery, as may be the case with a retrofit embodiment. In an alternate configuration, the cable could provide power to the sensor but the electrical signal from the sensor could be transmitted to a receiving device either incorporated into the microscope or external to the microscope.

In another aspect, a method of operating a microscope is described. The method includes the steps of rotating a nosepiece holding a plurality of different objective lenses such that one of the objective lenses is placed into an optical path of the microscope; measuring the rotational position of the nosepiece with a miniaturized inertial measurement sensor; and generating a signal with the inertial measurement sensor indicating the current position of the nosepiece, or equivalently the current objective lens in the optical path.

Several use cases are contemplated, including as a feature of an augmented reality microscope (ARM). See the PCT application of M. Stumpe, serial no. PCT/US2017/037212 filed Jun. 13, 2017, the content of which is incorporated by reference herein. In this use case, the microscope is associated with a computing device (typically a general purpose computer) which receives digital images of a sample as it would be viewed through the eyepiece of the microscope, with the digital images “augmented” as explained in the patent application. The signal from the inertial measurement sensor is used to generate metadata for the digital images that indicates the current object lens, or equivalently, magnification at which the digital image is captured.

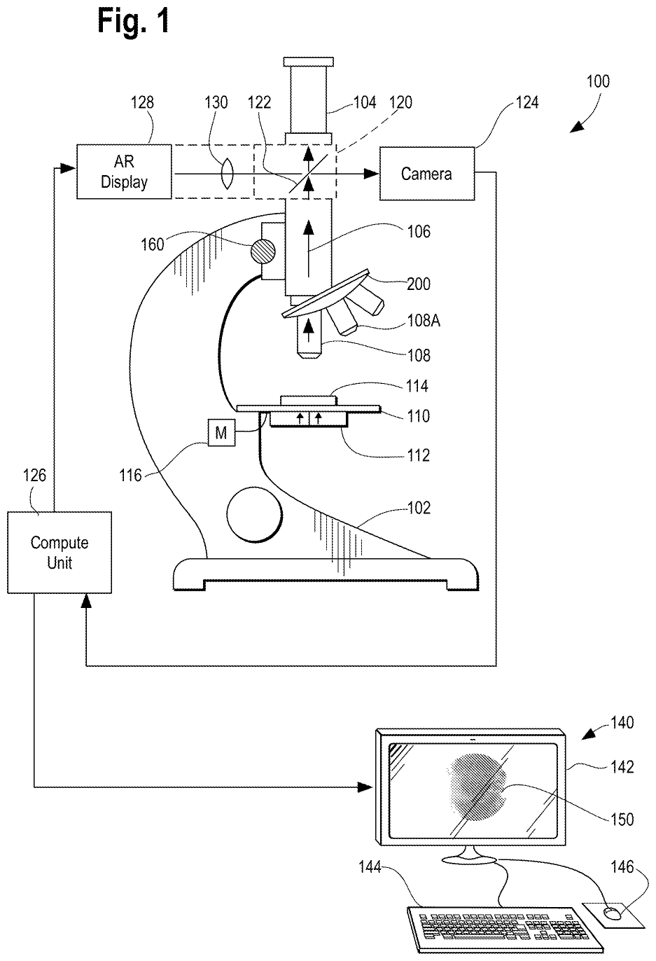

The following description of a microscope with the automatic objective lens identification is offered by way of example and not limitation. FIG. 1 is a schematic diagram of an augmented reality microscope system 100 for pathology, which is shown in conjunction with an optional connected pathologist workstation 140. The system 100 includes a conventional pathologist microscope 102 which includes an eyepiece 104 (optionally a second eyepiece in the case of a stereoscopic microscope). A stage 110 supports a slide 114 containing a biological sample. An illumination source 112 projects light through the sample. A microscope objective lens 108 in the optical path directs an image of the sample as indicated by the arrow 106 to an optics module 120. Additional lenses 108A and 108B are provided in the microscope for providing different levels of magnification. A focus adjustment knob 160 allows the user to change the distance between the slide 114 and the lens 108. The nosepiece 200 provides a mounting arrangement for a plurality of objective lenses 108, 108A, 108B, etc. The nosepiece is configured with the miniaturized inertial measurement sensor and wireless transmitter as will be explained below.

The microscope includes an optics module 120 which incorporates a component, such as a semitransparent mirror 122 or beam combiner/splitter for overlaying an enhancement onto the field of view through the eyepiece. The optics module 120 allows the pathologist to see the field of view of the microscope as he would in a conventional microscope, and, on demand or automatically, see an enhancement (heat map, boundary or outline, annotations, etc.) as an overlay on the field of view which is projected into the field of view by an augmented reality (AR) display generation unit 128 and lens 130. The image generated by the display unit 128 is combined with the microscope field of view by the semitransparent mirror 122. As an alternative to the semitransparent mirror, a liquid crystal display (LCD) could be placed in the optical path that uses a transmissive negative image to project the enhancement into the optical path. As another alternative, the semitransparent mirror 122 may be composed of two semitransparent mirrors, one relaying an image to the camera 124 and the other superimposing the image from the display unit into the observer's field of view.

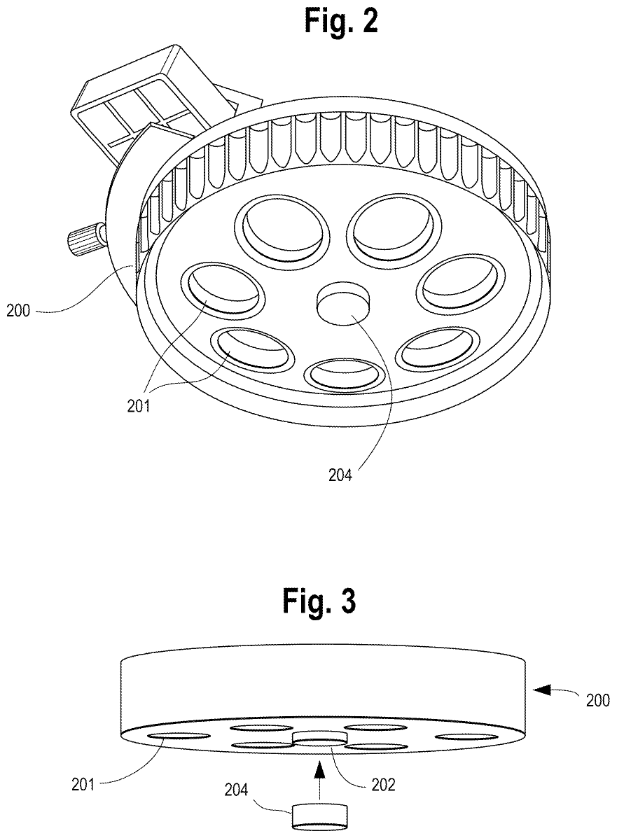

The optics module 120 can take a variety of different forms, and various nomenclature is used in the art to describe such a module. For example, it is referred to as a “projection unit”, “image injection module” or “optical see-through display technology.” Literature describing such units include US patent application publication 2016/0183779 (see description of FIGS. 1, 11, 12, 13) and published PCT application WO 2016/130424A1 (see description of FIGS. 2, 3, 4A-4C); Watson et al., Augmented microscopy: real-time overlay of bright-field and near-infrared fluorescence images, Journal of Biomedical optics, vol. 20 (10) October 2015; Edwards et al., Augmentation of Reality Using an Operang Microscope, J. Image Guided Surgery. Vol. 1 no. 3 (1995); Edwards et al., Stereo augmented reality in the surgical microscope, Medicine Meets Virtual Reality (19997) J. D. Westward et al (eds.) IOS Press, p. 102.

The semi-transparent mirror 122 directs the field of view of the microscope to both the eyepiece 104 and also to a digital camera 124. A lens for the camera is not shown but is conventional. The camera position and associated lens are designed to match the optical path length of light transmitted to the eyepiece 104 such that the sample 114 is in focus for the pathologist and the camera simultaneously. The camera may take the form of a high resolution (e.g., 16 megapixel) video camera operating at say 10 or 30 frames per second. The digital camera captures magnified images of the sample as seen through the eyepiece of the microscope. Digital images captured by the camera are supplied to a compute unit 126. A description of the compute unit 126 is not germane to the present disclosure and a detailed discussion is omitted. Alternatively, the camera may take the form of an ultra-high resolution digital camera such as APS-H-size (approx. 29.2×20.2 mm) 250 megapixel CMOS sensor developed by Cannon and announced in September 2015.

Briefly, the compute unit 126 includes a machine learning pattern recognizer which receives the images from the camera 124. The machine learning pattern recognizer may take the form of a deep convolutional neural network which is trained on a set of microscope slide images of the same type as the biological specimen under examination. Additionally, the pattern recognizer will preferably take the form of an ensemble of pattern recognizers, each trained on a set of slides at a different level of magnification, e.g., 5×, 10×, 20×, 40×. The pattern recognizer is trained to identify regions of interest in an image (e.g., cancerous cells or tissue, pathogens such as viruses or bacteria, eggs from parasites, etc.) in biological samples of the type currently placed on the stage. The pattern recognizer recognizes regions of interest on the image captured by the camera 124. The compute unit 126 generates data representing an enhancement to the view of the sample as seen by the user, which is generated and projected by the AR display unit 128 and combined with the eyepiece field of view by the semitransparent mirror 122. The AR display 128 and associated optics 130 are designed such that the display appears to the pathologist to be in approximately the same plane as the slide 114. This reduces or eliminates parallax between the projected information and the sample, such that movement of the pathologist's eye position does not result in movement of the AR display relative to the slide.

The essentially continuous capture of images by the camera 124, rapid performance of interference on the images by the pattern recognizer, and generation and projection of enhancements as overlays onto the field of view, enables the system 100 of FIG. 1 to continue to provide enhancements to the field of view and assist the pathologist in characterizing or classifying the specimen in substantial real time as the operator navigates around the slide (e.g., by use of a motor 116 driving the stage or by manually moving the slide), by changing magnification by switching to a different objective lens 108A or 108B, or by changing plane of focus by operating the focus knob 160.

The images captured by the camera are sent to the workstation 140 having a display 150, keyboard and pointing device 146. The image as seen through the eyepiece is shown at 150. The determination of the object lens 108 in the optical path by the inertial measurement sensor allows the system (e.g., compute unit 126 or workstation 140) to add metadata to the image 150 which indicates the current objective lens, or equivalent information such as the magnification at which the image 150 was obtained. Alternatively, items 126 and 140 may be combined into a single device such as a tablet, laptop or desktop computer.

FIG. 2 is a perspective view of the nosepiece 200 of FIG. 1 shown isolated from the microscope. The threaded apertures 201 provide a holding mechanism for holding a plurality of different lenses in the nosepiece; the number of apertures can vary, and is often 4, 5, 6 or 7.

The central portion of the nosepiece contains adequate real estate to enable a sensor unit 204 containing a miniaturized motion sensor and wireless transmitter to be mounted to the nosepiece. As shown in FIG. 3, the sensor 204 is coupled or mounted to the nosepiece 200 in any convention manner, e.g., via a sensor mount 202 which includes mechanical features to lock or affix the unit 204 in place. The sensor unit 204 can be mounted to the nosepiece using an adhesive, such as a flexible, sticky, adhesive putty known as “museum putty” or “poster putty” or the equivalent. The ideal location for mounting is the center of the nosepiece as shown in FIGS. 2 and 3, with room for the user's fingers to install objectives in the apertures 201, and out of harms way. The nosepiece includes a central, stationary hub (not shown) around which the objective holder rotates. The sensor should be affixed to the outer, rotating component, e.g., with an annular attachment.

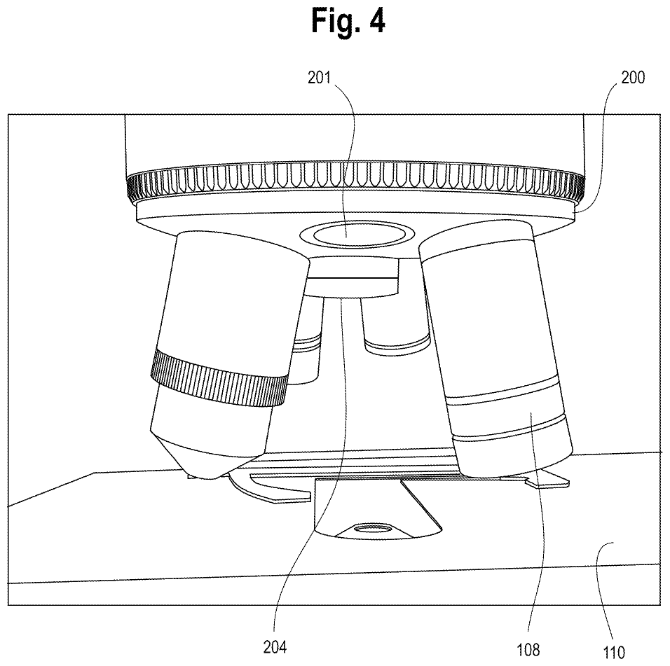

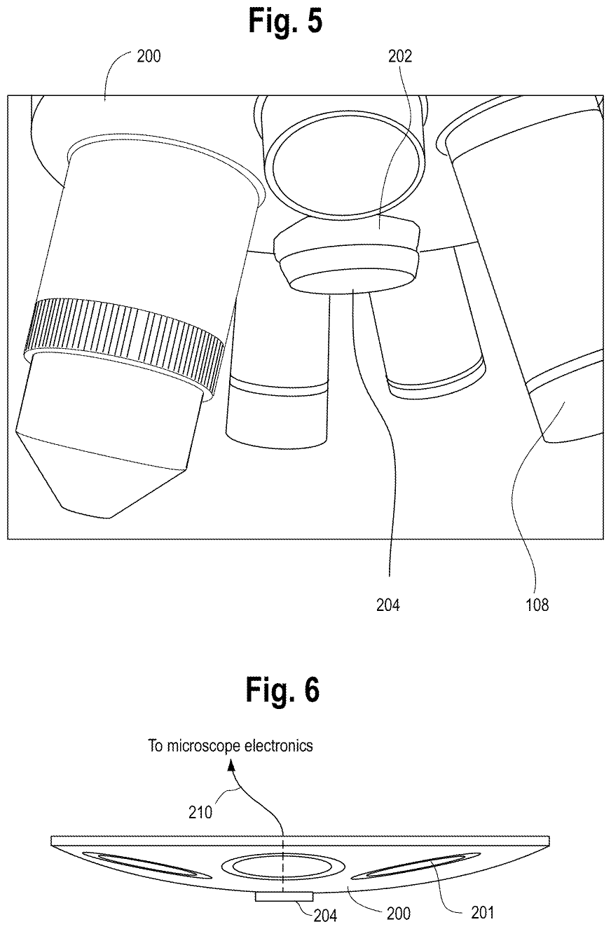

FIGS. 4 and 5 show the sensor 204 installed on the nosepiece via a mounting arrangement 202 best shown in FIG. 5.

As noted earlier, a microscope can be manufactured and furnished with the inertial measurement sensor as standard or optional equipment. In this configuration, shown in FIG. 6, the sensor unit 204 is affixed or otherwise secured to the nosepiece 200 and a cable 210 provide power to the batter for the sensor in the unit 204. In this embodiment, the unit 204 optionally may not include the wireless transmitter, in which case the sensor produces electrical signals which are carried by the cable 210 to internal electronics of the microscope which then presents information on the current objective lens to the user via a suitable interface. Additionally, if the microscope is equipped with a camera, as images are captured by the camera (e.g., in accordance with the configuration of FIG. 1 or a similar configuration) metadata for the images is generated which includes data indicating what objective lens was in the optical path at the time, or equivalently, the magnification of the images, based on position data generated by the sensor in the unit 204.

High volume applications, including smart phones and gaming controllers, have driven down cost and size of accelerometers and gyros. The applications have also driven increased integration with wireless components and decreased power consumption. Further considerations for an implementation are minimization of software integration effort, fool-proof, and long battery life. In the illustrated embodiment, we used a MetaMotionC inertial measurement sensor with built-in wireless transmitter. Mbient Labs, the manufacturer, has developed a platform with several compact, wireless motion sensors and a Linux-compatible software development kit. The underlying Bosch chipset in the MetaMotionC provides advanced functionality and computing resources such as sensor fusion that converts raw signals into an absolute orientation vector. The resolution, range, and accuracy of the inertial measurement unit in the sensor are more than sufficient for detecting nosepiece orientation. For an 8-position nosepiece, angle changes between objectives will be 360/7=51.4 degrees.

Software Integration

Mbient Labs provides a hub (Raspberry Pi based) for Initial development. This may also come in handy for other applications such as component testing. Free and open source software development kits (SDK's) are available in a variety of languages, including C++, Java, and Python. Many examples are provided. Apps, such as MetaBase, are also available for iOS and Android. This allows rapid set-up of the sensor. Data can be streamed to the external computing device (e.g., smartphone) or logged on device and downloaded later.

Sensor Operation

The MetaMotionC board is built around the Nordic RF52 system-on-chip platform, which integrates wireless communication (Bluetooth), CPU and sensor communication/logging. A c

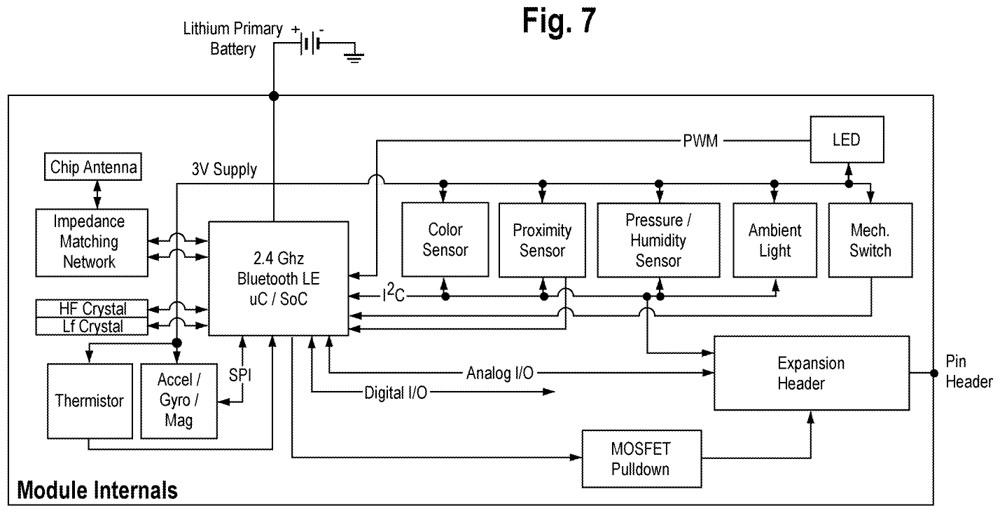

circuit diagram for the MetaMotionC unit is show in FIG. 7. All inertial measurement sensors needed for the present uses are provided by a Bosch BM1160 chip in the unit. This device includes 3-axis accelerometers and gyroscopes (both based on MEMS technology). It also includes a 3-axis magnetometer and computational features to synthesize signals from multiple sensors and report absolute orientation.

Wireless

Bluetooth (BLE) on the Nordic chip provides a wireless link to access sensor data. Range: Line of sight indoors is ˜10 m. Battery life: The MetaMotionC is powered by a Li-ion coin-cell battery (CR2032, typically ˜200 mAh). Power management features are built into the primary power consuming chips (BM1160 and nRF5832). These features will likely need to be managed to achieve >1-year battery life. For example, there is a lower power accelerometer command in the iOS API.

Configuration

The device can be configured in 3 ways. Note that each MetaMotionC is configured as a slave peripheral, which can only be connected to 1 master device at a time. Beacon: Sensor data is advertised to the world to be picked up by any Client (e.g. Smartphone or BLE dongle).

Stream: Sensor data is sent live to the Client while connected. Log: Sensor data is kept in the MetaMotionC memory (8 MB) to be downloaded at a later time.

Determining Orientation

The Bosch chip determines absolute sensor orientation, as indicated above. Gyroscopic drift is one of the key considerations for sensor accuracy, as all 3 axes of the gyro are sensitive to rotational acceleration and not absolute angle. Nosepiece heading (or clocking angle) can be derived from the z-axis of the accelerometer (where gravity provides asymmetry) and the magnetometer in the device. If the sensor were mounted in a horizontal plane, it's z-axis would be parallel to the direction of the earth's gravitational force. This degenerate condition eliminates sensitivity of the accelerometer to pure rotation about the z-axis. Fortunately, nosepieces are commonly tilted by ˜15 degrees from horizontal. This introduces a component of gravity to the x and y axes, which is orientation-dependent.

System Interconnect and Sensor Configuration

The simplest implementation will include just 1 sensor unit communicating with an external computer, e.g., an external computer running the ARM system.

One way to prevent the failure mode of the microscope being moved (rotated), which would confuse the relationship between absolute nosepiece heading and objective in use, would be to attach a second sensor to the microscope frame. Differential headings between the two sensors would then provide a signal insensitive to motion of the overall system.

Installation and Calibration

As outlined above, the sensor can be mounted over the center of the nosepiece (see FIGS. 2, 3). To ease battery replacement, a re-usable (non-permanent) attachment mechanism should be used. A simple approach is “poster putty”. Once the sensor is affixed, it will be necessary to define which objectives are at which locations. This will require both determining the absolute angles associated with nosepiece positions (as opposed to intermediate positions) and assigning magnification value to those positions. Note that the system will not detect if a user changes the objective for a given position. This failure mode plagues conventional nosepiece encoders also.

System set-up should include a step where these values can be determined. For example, the user could be asked to rotate the nosepiece around a full 360 degrees. The system will detect the discrete locations associated with each position (the accelerometer signal will detect the “click” associated with snapping into a set position). The user is asked to manually enter an objective magnification value for each of these positions. This calibration can be performed on the attached computing platform or smartphone receiving wireless signals from the sensor unit 204 using a set-up app such as the MetaBase app which is provided by Mbient Labs.

Initial calibration could be semi-automated for systems with a camera attached (like the ARM) using a target or calibration slide that has features of known dimensions. The user would simply put that slide into the field of view and rotate the nosepiece through all positions of interest.

### FURTHER CONSIDERATIONS

A primary motivation for development of the augmented reality microscope (ARM) technology is the need for a platform that can expand access to AI (artificial intelligence) in pathology and other microscope applications, with a vision that integrating an AI feature directly into a conventional microscope can break down technological, economic and behavioral barriers. To fully realize the impact potential, ARM deployment options should include retrofit of existing microscopes for both cost and behavior reasons.

Within pathology, many clinicians are wedded to their particular microscope, having spent years working on the same device and are reluctant to switch to a newer design, even one from the same supplier. Another behavioral consideration within pathology is the frequent switching between magnifications within a specific specimen review. An effective ARM solution should allow this to be done seamlessly, i.e. to automatically adapt to microscope objective changes and rapidly provide accurate results. The AI system will benefit from a fail-safe signal from the microscope. The solution presented in this document a) allows for retrofit onto existing microscopes, while reducing hardware cost and adoption risk; b) it is robust, in that it should work across a range of ambient conditions and have high up-time; c) it is extremely accurate and should have exceptionally low error rate (<<1%); d) it is affordable, and hardware costs are minimal, and e) it is easy to install, low cost and foolproof.

While a preferred and alternative embodiments are described with some detail above, variation from the disclosed embodiments can of course be made. All questions concerning scope of the disclosure are to be answered by reference to the appended claims.

1-25. (canceled)

26. A microscope comprising:
a plurality of objective lenses, one of which is located in an optical path of the microscope, and
a nosepiece comprising a mechanical fixture having discrete positions which serve to hold the plurality of different objective lenses and which is rotatable about an axis to place one of the plurality of different objective lenses into the optical path,
wherein the nosepiece is configured with:
a) an inertial measurement sensor configured to detect the current position of the nosepiece thereby detecting which objective lens of the plurality of different objective lenses is in the optical path, and
b) a wireless transmitter coupled to the inertial measurement sensor and configured to transmit information indicative of the current position of the nosepiece to an external computing device.

27. The microscope of claim 26, wherein the inertial measurement sensor comprises a controller configured to synthesize signals from multiple inertial measurement sensors to determine an absolute orientation of the inertial measurement sensor.

28. The microscope of claim 26, wherein the inertial measurement sensor and wireless transmitter are integrated as a single unit and powered by a battery.

29. The microscope of claim 28, further comprising a mounting arrangement for mounting the single unit to the nosepiece such that if the single unit is removed from the nosepiece to replace or recharge the battery the single unit can be installed in the same orientation with respect to the nosepiece as it was when it was removed.

30. The microscope of claim 26, wherein the nosepiece further comprises a magnetometer.

31. A microscope having a nosepiece comprising a mechanical fixture having discrete positions which serve to hold a plurality of different objective lenses, one of which is located in an optical path of the microscope,
wherein the nosepiece further comprises an inertial measurement sensor configured to generate an electrical signal that is indicative of at least one of the position of the nosepiece or the location of the objective lens, of the plurality of different objective lenses, that is located in the optical path, and
a cable for carrying the electrical signal to internal electronics of the microscope.

32. The microscope of claim 31, wherein the inertial measurement sensor comprises a controller configured to synthesize signals from multiple inertial measurement sensors to determine an absolute orientation of the inertial measurement sensor.

33. The microscope of claim 31, wherein the cable is configured to supply power to the inertial measurement sensor.

34. The microscope of claim 31, wherein the internal electronics of the microscope are configured to report at least one of the current position of the nosepiece or the current position of the objective lens in the optical path to an external computing device.

35. The microscope of claim 31, wherein the nosepiece further comprises a magnetometer.

36. A microscope comprising
a plurality of objective lenses, one of which is located in an optical path of the microscope, and
a nosepiece comprising a mechanical fixture having discrete positions which serve to hold the plurality of different objective lenses and which is rotatable about an axis to place one of the plurality of different objective lenses into the optical path,
wherein the nosepiece is configured with:
a) an inertial measurement sensor configured to detect the current position of the nosepiece thereby detecting which objective lens of the plurality of objective lenses is in the optical path, and
b) a cable for carrying electrical power to the inertial measurement sensor.

37. The microscope of claim 36, further comprising a wireless transmitter configured to transmit a signal indicative of at least one of the current position of the nosepiece or the current location of the objective lens, of the plurality of different objective lenses, that is located in the optical path.

38. The microscope of claim 36, wherein the nosepiece further comprises a magnetometer.

39. A method of operating a microscope, comprising:
rotating a nosepiece holding a plurality of different objective lenses such that one of the objective lenses is placed into an optical path of the microscope;
measuring the rotational position of the nosepiece with an inertial measurement sensor; and
generating a signal with the inertial measurement sensor that is indicative of at least one of the current position of the nosepiece or the current location of the objective lens, of the plurality of different objective lenses, that is located in the optical path.

40. The method of claim 39, further comprising transmitting the signal to an external computing device.

41. The method of claim 39, wherein the microscope further comprises a camera, and wherein the method further comprises using the signal to generate metadata for an image captured with the camera, the metadata indicating at least one of the magnification of the image or the identity of the objective lens, of the plurality of different objective lenses, that was located in the optical path to capture the image captured with the camera.

42. A nosepiece for a microscope, comprising:
a mechanical fixture having discrete positions which serve to hold a plurality of different objective lenses and which is rotatable about an axis to place one of the plurality of different objective lenses into an optical path of the microscope,
wherein the nosepiece is configured with an inertial measurement sensor configured to detect the current position of the nosepiece thereby detecting which objective lens of the plurality of different objective lens is in the optical path.

43. The nosepiece of claim 42, further comprising a wireless transmitter coupled to the measurement sensor and configured to transmit information indicative of the current position of the nosepiece to an external computing device.

44. The nosepiece of claim 42, wherein the inertial measurement sensor and wireless transmitter are integrated as a single unit and powered by a battery.

45. The nosepiece of claim 44, further comprising a mounting arrangement for mounting the single unit to the nosepiece such that if the single unit is removed from the nosepiece to replace or recharge the battery the single unit can be installed in the same orientation with respect to the nosepiece as it was when it was removed.
